(19) United States
(12) Patent Application Publication
(10) Pub. No.: US 2015/0148112 A1
(43) Pub. Date: May 28, 2015

(54) EXPANDABLE GRAIN TANK

(71) Applicant: AGCO Corporation, Hesston, KS (US)

(72) Inventor: Frederic Ducroquet, Newton, KS (US)

(21) Appl. No.: 14/552,663

(22) Filed: Nov. 25, 2014

Related U.S. Application Data
(60) Provisional application No. 61/908,218, filed on Nov. 25, 2013.

(51) Int. Cl. A01D 41/12

(52) U.S. Cl. CPC A01D 41/1226
USPC 460/119

(57) ABSTRACT

A grain storage container in a combine harvester comprises a front panel, a rear panel, and a first side panel mounted fore and aft on a lower hinge assembly. The first side panel comprises a top edge and a lower edge that form a non-zero angle relative to each other. First and second foldable materials couple the first side panel to the front and rear panels. The first foldable material is attached to the front panel and the first side panel. The second foldable material is attached to the rear panel and the first side panel. The front and rear panels further comprise a respective first fixed portion coupled to a respective pivotal second portion. Each pivotal second portion is coupled to the respective fixed portion. A front-facing surface of the second portion of the front panel and a rear-facing surface of the second portion of the rear panel in an expanded grain storage container position are adjacent to an interior surface of the first side panel in the grain storage container configured in a closed position.

### CROSS-REFERENCE TO RELATED APPLICATION

The present application claims the benefit of and priority from U.S. Provisional Application No. 61/908,218, the entire disclosure of which is hereby incorporated by reference.

### TECHNICAL FIELD

The present disclosure is generally related to bulk storage containers and, more particularly, grain storage containers for combine harvesters.

### BACKGROUND

Combine harvesters harvest crop and collect the harvested crop in a storage container (also, grain tank, grain bin, etc.) mounted onto a frame of the combine harvester. From there, the harvested crop, such as grain, is unloaded to the bed of a receiving vehicle, such as a grain truck bed. In the past, some manufacturers have used storage containers with very low container heights, with the storage container installed on the side of the separator unit/threshing system. Because the weight distribution was not consistent between the left and right front tires, saddle tanks became more popular. Today, many combine harvester manufacturers install the storage container over the separator unit/threshing system. However, capacity limits are a shortcoming to this design. Further, over the years, the separator unit/threshing system has grown and the overall combine harvester size has been reduced for easier transportation. Given the constraints to increasing storage container volume (including road size limits), grain storage container extensions have been introduced above the storage container. One shortcoming to the implementation of the extensions includes a rise in height of the center of gravity of the grain. By increasing the height of the center of gravity, stability issues may arise (e.g., on slopes) and/or excessively high weight transfers from axle to axle may occur when the combine harvester is traveling uphill or downhill (which may create an overload on tire and/or frame components and/or compaction of the soil). Indeed, one estimate is that for many of today's largest combine harvesters, more than fifty (50) percent of the grain volume may be carried on the storage container extensions, which may be unsuitable for any future increases to storage container capacity.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates, in fragmentary front perspective view an example combine harvester on which is provided an example embodiment of an expandable grain tank in an expanded position.

FIG. 2 is a schematic diagram that illustrates, in fragmentary front perspective view an example combine harvester on which is provided an example embodiment of an expandable grain tank in an expanded position.

FIG. 3 is a schematic diagram that illustrates, in fragmentary rear overhead perspective view an example combine harvester on which is provided an example embodiment of an expandable grain tank in an expanded position.

FIG. 4 is a schematic diagram that illustrates, in fragmentary front perspective view an example combine harvester on which is provided an example embodiment of an expandable grain tank in a closed position.

FIG. 5 is a schematic diagram that illustrates, in fragmentary rear perspective view an example combine harvester on which is provided an example embodiment of an expandable grain tank in a closed position.

FIGS. 6A-6C are schematic diagrams that illustrate in fragmentary rear overhead perspective views the folding of a foldable material coupled between respective pivotal side panels and the front and rear panels in a closed position of an example embodiment of an expandable grain tank.

FIG. 6D is a schematic diagram that illustrates in close-up, overhead perspective fragmentary view, an example configuration of foldable materials of an example embodiment of an expandable grain tank.

FIG. 7 is schematic diagram of another example embodiment of an expandable grain tank where upper and lower hinge assembly planes are used to enable expansion in maximum storage capacity.

### DESCRIPTION OF EXAMPLE EMBODIMENTS

Certain embodiments of an expandable grain tank are disclosed that provide for an increase in grain tank capacity of a grain tank of a combine harvester while permitting a reduction in a width of the grain tank in a closed position (such as a transport mode). In some embodiments, the expansion in grain storage capacity is achieved without raising the center of gravity of the grain. For instance, in one embodiment, the grain tank comprises a solid base and front and rear panels. Further, the grain tank comprises two side panels (side panels) mounted on a respective lower, fore and aft hinge assembly, enabling the side panels to extend on the top of the grain tank to be used as top covers in the closed position. In a road transport or storage mode, the two side panels are collapsed or in a closed position, providing protection for the grain tank from the environment (e.g., rain) while also reducing the maximum width of the grain tank (e.g., as measured in a lower portion (e.g., lower half) of the grain tank). In an operational or working mode, the side panels are expanded (e.g., opening up the grain tank) to increase the capacity (e.g., maximum grain volume) of the grain tank. Foldable materials composed of, for instance, elastomeric (e.g., rubber) and/or textile (e.g., canvass or other woven material) material, may be used to fill the gap between static (e.g., fixed) grain tank parts and the pivotal side panels.

Digressing briefly, as set forth in the background, some existing grain tanks of combine harvesters use a hinge assembly in the upper half (e.g., top plane) of the grain tank, to which extension panels mount to permit an increase in capacity. However, such structures also significantly increase the center of the gravity of the stored grain, which may reduce stability under certain transport conditions. In contrast, one or more embodiments of the disclosed expandable grain tank provide for one or more pivotal side panels on a plane that is lower than the usual upper plane of the combine harvester (or upper plane of the grain tank), enabling an increase in capacity while providing for an improvement in stability. Also, the pivotal features of the one or more side panels enable a reduction in the maximum width of the grain tank when the grain tank is closed, facilitating road travel.

Having summarized certain features of one or more embodiments of expandable grain tanks, reference will now be made in detail to the description of the disclosure as illustrated in the drawings. While the disclosure will be described in connection with these drawings, there is no intent to limit it to the embodiment or embodiments disclosed herein. For instance, though depicted in the figures (for which a corresponding description follows) as residing on a host machine embodied as a combine harvester with a given axle arrangement, other combine harvesters of the same or a different axle arrangement or other host machines may similarly benefit from the various features of the disclosed grain tank embodiments, and hence are contemplated to be within the scope of the disclosure. Also, in some embodiments, the expandable grain tank may be used on a static implementation, such as where the storage container resides on the ground or on another static structure residing on the ground during normal operations. Further, though depicted in the accompanying figures as a saddle tank, other types of grain tanks may be used in some embodiments.

Also, reference herein to grain tanks is intended to encompass the same or similar structures of a different name, such that the terms storage container, storage bin, grain tank, storage tank, etc. are interchangeable according to the present disclosure, though emphasis is on the terms grain tank or storage container. For instance, although grain is described as bulk material that occupies the interior volume of the grain tank, storage containers for other bulk material may similarly apply. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

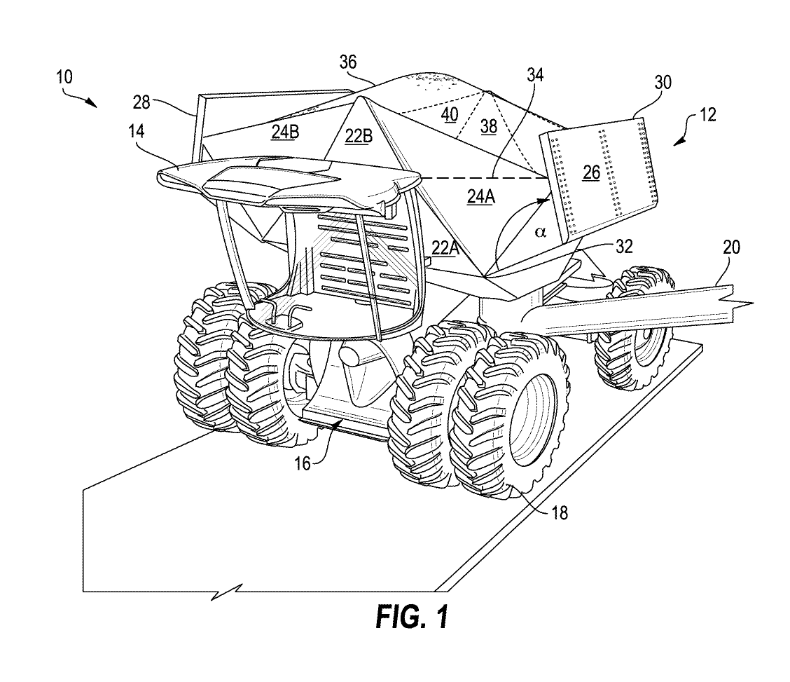

Reference is made to FIG. 1, which illustrates an example host machine for an embodiment of a grain tank, the host machine embodied as a combine harvester (hereinafter, simply referred to also as a combine) 10. As explained above, one having ordinary skill in the art should appreciate in the context of the present disclosure that the example combine 10 depicted in FIG. 1 is merely illustrative, and that in some embodiments, combines of other designs or other machines may be used as a host for certain embodiments of grain tanks disclosed herein. The combine 10 is shown in fragmentary view with only select features to avoid obfuscating features of a supported grain tank 12. For instance, the combine 10 is shown with a portion of a cab 14 (shown in cut-away, revealing a frame of the cab 14) that is mounted to a machine frame 16. Coupled to the machine frame 16 are plural wheels 18 (although in some embodiments, tracks may be used at least in part) that enable travel along a road or field. The frame 16 also supports the grain tank 12 at the base of the grain tank 12. Also shown is a portion of an unloading spout 20, which is extended from its stowed position. The grain tank 12 comprises a front panel 22 that in one embodiment comprises a fixed, substantially upright lower portion 22A and a pivotal upper portion 22B. The pivotal upper portion 22B is optional, and is configured to pivot (e.g., at a hinge assembly located approximately in the plane of the top of the cab 14) in the rearward direction when the grain tank 12 is transitioning from an expanded position (as shown in FIG. 1) to a closed position. Also shown is a foldable material 24 comprising a left front foldable material 24A and a right-front foldable material 24B. The foldable material 24 is attached to the front panel 22 on opposing sides of the front panel 22. The foldable material 24 may be any material that can withstand the pressure of the stored grain (or other bulk material) while still being elastically deformable. For instance, the foldable material 24 is capable of folding during the closed position of the grain tank 12, and then returning to the same form depicted in FIG. 1 in the expanded position of the grain tank 12. In one embodiment, the foldable material 24 is embodied as an elastomeric material, such as rubber, though in some embodiments, the foldable material may be composed of a textile material or a combination of elastomeric material and textile material, among other foldable materials. Also shown in FIG. 1 are side panels 26 and 28. The side panels 26 and 28 are coupled to the front panel 22 through the foldable materials 24. For instance, the foldable materials 24A and 24B are attached to both the side panels 26 and 28 and the front panel 22. That is, the side panel 26 is attached to one end of the foldable material 24A and the front panel 22 is attached to the other end of the foldable material 24A. Similarly, the side panel 28 is attached to one end of the foldable material 24B and the front panel 22 is attached to the other end of the foldable material 24B. The attachment may be according to any known fastening mechanisms, such as via tacks, pins, screws, bolts, stitching, adhesion, etc. Focusing on the side panel 26, with similar applicability in this example embodiment to the side panel 28, the side panel 26 comprises a top fore and aft edge 30 and a lower fore and aft edge 32, the lower edge 32 mounted to a hinge assembly. The top and lower edges 30 and 32 form a defined (non-zero) angle, α, relative to each other. For instance, the side panel 26 may be configured in a fixed, “L” shape (e.g., ninety-degrees) when viewed in a rear end view (ignoring, for instance the front and rear angled sides extending from the front and rear edges of the side panel 26, the angled sides used to prevent spillage of the grain from the front or rear of the side panel 26). In one embodiment, a may be one-hundred (100) degrees, though a may be configured with other angles (e.g., within a range of ninety (90) to one hundred-twenty (120) degrees in some embodiments). In the expanded position depicted in FIG. 1, the side panel 26 is expanded to enable an increased storage capacity, facilitated by the elastic deformability or foldability of the foldable material 24. Note that in one embodiment, the dashed line 34 represents where the foldable material 24A folds when transitioning to a closed position, though other locations or quantity of fold points may be used in some embodiments. In addition, through the outward pivoting of the side panels 26 and 28 (and hence the expansion in capacity), the maximum width of the grain tank 12, such as measured in the lower portion (e.g., between the points adjacent the bend in the side panel 26 and like location in the side panel 28) is increased relative to the closed position, enabling an increase in volume without a concomitant rise in the center of gravity of the stored grain 36. Also shown in phantom is a rear panel 38 and foldable material 40 coupling the rear panel 38 to the side panels 26 and 28.

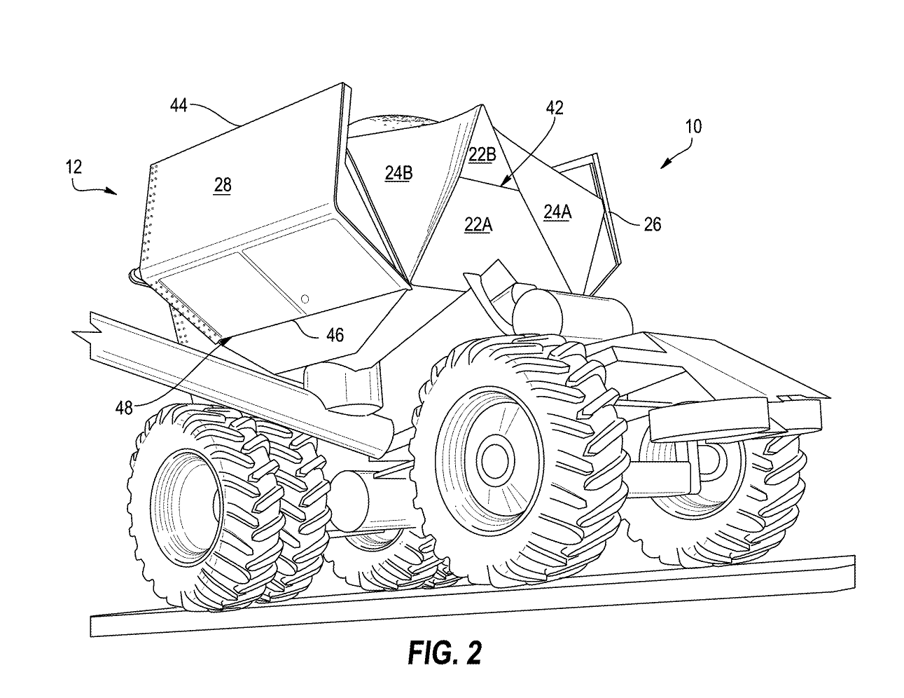

FIG. 2 shows another fragmentary view of the combine 10 illustrated in FIG. 1, with the frame of the cab 14 omitted to further reveal certain features of the grain tank 12, such as the front panel 22, as well as further illustration of the features of the side panel 28. The front panel 22 comprises the substantially upright, lower fixed portion 22A and the pivotal upper portion 22B. The portions 22A and 22B are separated by a hinge assembly 42 that enables the upper portion 22B to pivot rearwardly relative to the lower portion 22A. Also shown are foldable materials 24A and 24B that are each attached to the front panel 22 (e.g., along or proximal to each side of the upper 22B and lower 22A portions) and to respective side panels 26 and 28. As explained above, the side panels 26 and 28, in one embodiment, are of the same structure. Focusing on the right side panel 28, the side panel 28 comprises a fore and aft top edge 44 and lower edge 46, the edges 44 and 46 defining a defined angle (e.g., substantially “L” shaped) similar to that previously described for the side panel 26. The side panel 28 is mounted fore and aft on a lower hinge assembly 48 adjacent the edge 46, which, like the side panel 26, enables the side panel 28 to be pivoted between an expanded position (as depicted in FIG. 2) and a closed position.

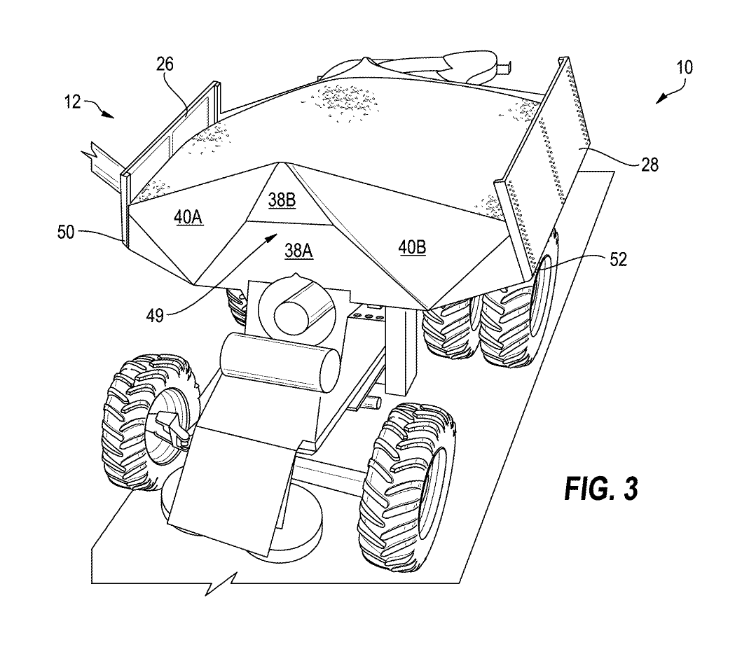

Referring now to FIG. 3, shown is the combine 10 in overhead, right rear perspective view, which again shows the grain tank 12 in an expanded position. In one embodiment, the rear panel comprises a fixed, substantially upright lower portion 38A and an optional upper pivotal portion 38. The upper portion 38B is mounted to a transverse hinge assembly 49, which enables the upper portion 38B to pivot forwardly relative to the lower portion 38A (e.g., when transitioning between the expanded and closed positions). Disposed between the side panel 26 and the rear panel 38 is the foldable material 40A, which is attached to both the side panel 26 and the rear panel 38 (e.g., affixed to both the upper 38B and lower 38A portions). The foldable material 40A, similar to the foldable material 24A (FIG. 2), folds when the side panel 26 transitions from the expanded position (shown in FIG. 3) to a closed position. Similarly, the foldable material 40B is disposed between, and attached to, the side panel 28 and the rear panel 38 (e.g., attached to the upper 38B and lower 38A portions), and which similarly folds during the transition from expanded to closed positions. As noted in FIG. 3, a maximum width of the grain tank 12 is measured from a lower portion of the grain tank 12 (e.g., the bend in the side panels 26 and 28), such as taken at locations 50 and 52, respectively. The maximum width of the grain tank 12 changes (e.g., in dimension, and from what part in the lower portion of the grain tank 12 is referenced) when measured during the expanded position (e.g., greater) versus when measured during the closed position.

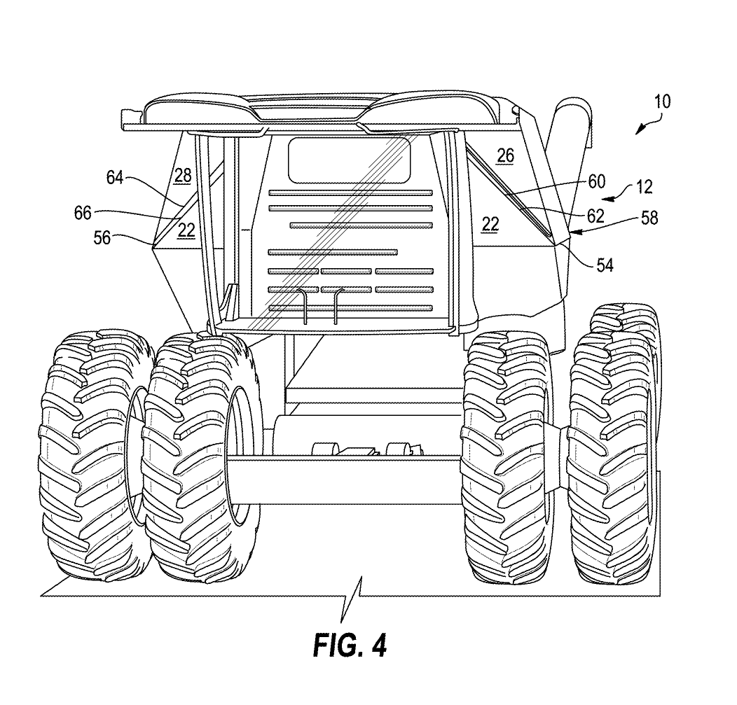

Referring now to FIG. 4, shown is a front perspective view of the combine 10 that illustrates the change in maximum width, as measured at locations 54 and 56, when the grain tank 12 is in the closed position. Once again, the maximum width is measured at the lower portion (e.g., lower half) of the grain tank 12. The maximum width measured between 54 and 56 is smaller than when measured at maximum width locations 50 and 52 in the expanded position (e.g., FIG. 3). For instance, in a six hundred (600) bushel capacity combine 10, the maximum width when closed or folded (e.g., as measured between locations 54 and 56 in FIG. 4) is three (3) meters, and at the same or similarly referenced height (e.g., at locations 50 and 52 of FIG. 3), at 5.4 meters (unfolded or expanded). Note that the values provided here are merely illustrative, and that other values revealing the substantial difference in maximum width between the closed and expanded position may achieved based on the given design and/or capacity of the machine used. As noted from FIG. 4, in the closed position, the side panel 26 is pivoted at a fore and aft hinge assembly 58 in a manner that enables the side panel 26 to serve as a top cover of the grain tank 12. In the closed position, an edge 60 of the interior, lower portion of the side panel 26 is adjacent an edge 62 (e.g., left edge) of the front panel 22. Similarly, in the closed position, the side panel 28 is pivoted at a fore and aft hinge assembly 48 (FIG. 2) in a manner that enables the side panel 28 to serve as a top cover of the grain tank 12. In the closed position, an edge 64 of the interior, lower portion of the side panel 28 is adjacent an edge 66 (e.g., right edge) of the front panel 22.

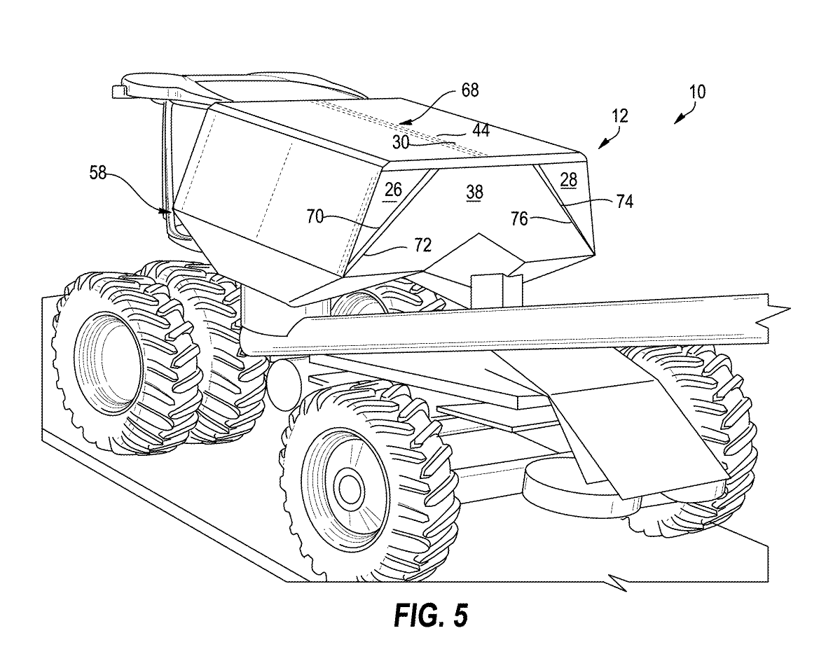

FIG. 5 shows the combine 10 and grain tank 12 in left, rear perspective view, further illustrating the arrangement of panels when the grain tank 12 is in the closed position. As shown, the side panel 26 pivotally swings at the hinge assembly 58, enabling the panel 26 to serve as a top cover for the grain tank 12. Similarly, the hinge assembly 48 (FIG. 2) enables the side panel 28 to pivotally swing such that the side panel 28 also serves as a top cover for the grain tank 12. In one embodiment, the top edge 30 of the side panel 26 is adjacent the top edge 44 of the side panel 28 at a fore and aft midline 68 of the grain tank 12. In some embodiments, the top edges of each side panel may be adjacent to each other offset from the midline. In one embodiment, the edges 30 and 44 may abut to each other at the midline 68, or in some embodiments, overlap (e.g., tongue and groove fashion), with or without an elastomeric (or other material) sealing member. The mating of the side panels 26 and 28 at the top of the grain tank 12 serves to protect the internal contents from the environment. Similar to the arrangement of the front 22 and side panels 26 and 28, in the closed position, an interior edge 70 of the side panel 26 is adjacent an edge 72 of the rear panel 38. Similarly, in the closed position, an interior edge 74 of the side panel 28 is adjacent an edge 76 of the rear panel 38.

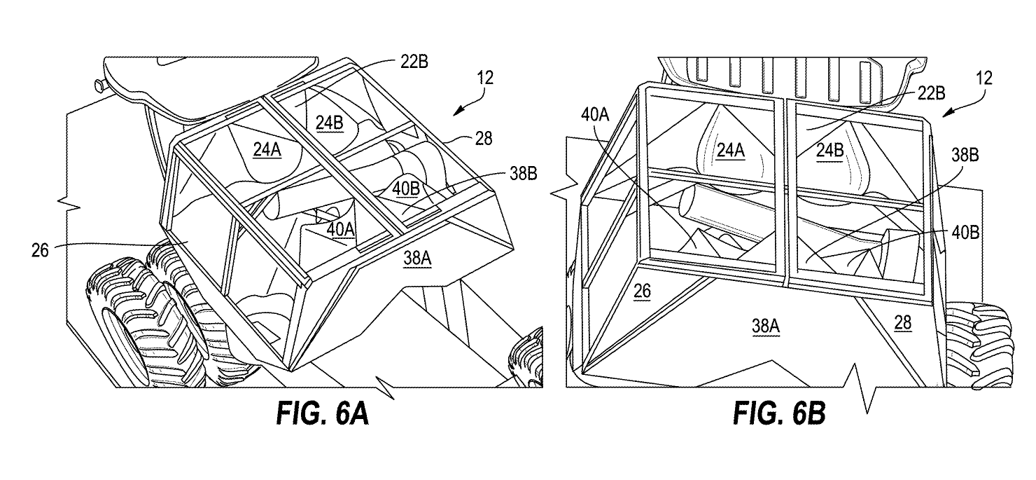

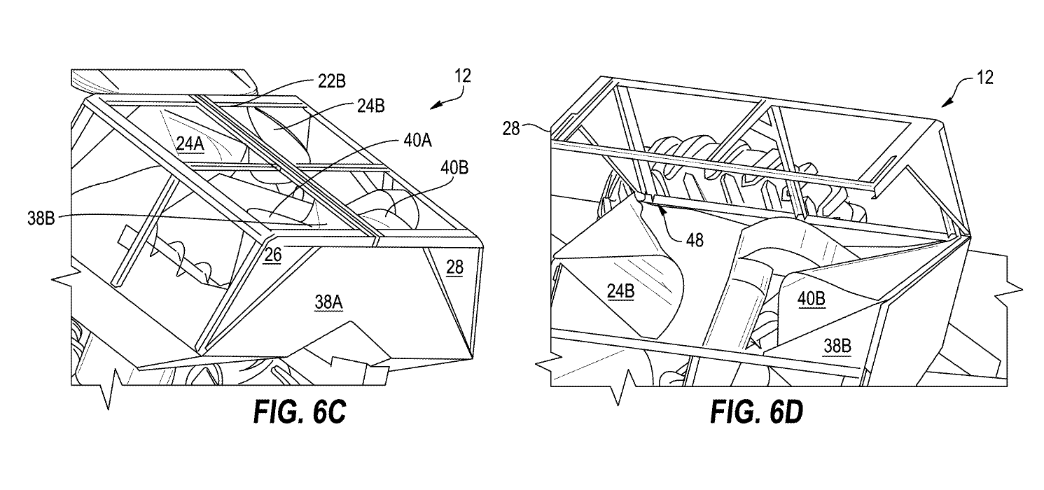

Referring to FIGS. 6A-6C, in embodiments where the rear panel 38 and front panel 22 of the grain tank 12 have respective upper pivotal portions 38B and 22B, the upper pivotal portion 38B swings forwardly and downwardly to lie underneath the closed side panels 26 and 28 and the upper pivotal portion 22B swings rearwardly and downwardly to lie underneath the closed side panels 26 and 28. Also, the foldable materials 24 (e.g., 24A and 24B) and 40 (e.g., 40A and 40B) are shown folded over and underneath the side panels 26 and 28. For instance, using the foldable material 24A as a representative example, the foldable material 24A folds over when the side panels 26 and 28 begin to, and ultimately, close, enabling the foldable material 24A to transition with the side panel 26 (and the front upper portion 22B) during the closing and expanding operations of the storage tank 12. As shown, the foldable materials 24 and 40 remain protected from the environment in the closed position.

In FIG. 6D, the side panel 28 is depicted opened up and detached (e.g., not part of normal operations) from the foldable materials 24B and 40B to illustrate in closer view the foldable materials 24B and 48B as each are configured in the closed position relative to the upper rear panel 38B. Also note an example configuration of the fore and aft hinge assembly 48 (which similarly represents in structure the fore and aft hinge assembly 58, and all the other aforementioned hinges of the grain tank 12) to which the side panel 28 is mounted, which includes in one embodiment three (3) pivoting attachment segments, including two outer and one middle hinge assembly segment, though some embodiments may have additional hinge assembly segments or fewer than three (3) in some embodiments.

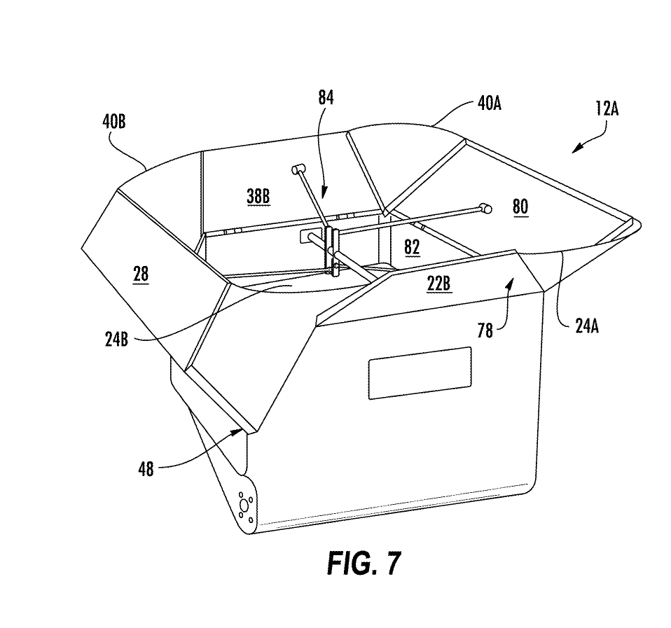

Attention is now directed to FIG. 7, which illustrates, in front right perspective view, another example embodiment of a grain tank 12A that uses fore and aft upper and lower hinge assemblies 78 and 48, respectively. Although shown in FIG. 7 using the lower-hinged pivotal side panel 28 as described previously and a side extension panel 80 pivotally coupled (via an upper hinge assembly 78) to a fixed side panel 82, the roles may be reversed in some embodiments (e.g., the side panel 26 with a lower hinge assembly is used in combination with a side extension panel plus upper hinge assembly in place of the pivotal side panel 28). The gaps between the side panel 28, rear panel 38, side extension panel 80, and front panel 22 may be occupied (and coupled) by foldable material 40B, 40A, 24A, and 24B in a manner as similarly described. In the embodiment depicted in FIG. 7, there is an increase in the center of gravity of any bulk material (by virtue of the capacity increase due to the side extension panel 80 with its upper hinge assembly 78), yet less than conventional storage tanks given the use of the side panel 28 with its lower hinge assembly 48. Also shown in FIG. 7 is a panel operating mechanism 84, which comprises a push-up auger with push rods attached to the panels 22B and 38B, 26, and 28 (and in the embodiment depicted in FIG. 7, to side extension panel 80 in place of panel 26). A similar mechanism is currently used to open and close upper-hinged side extension panels of existing grain tanks. The panel operating mechanism 84 may be electrically or hydraulically powered and controlled via switching mechanisms on an operator's console in the cab 14 (FIG. 1) or elsewhere (e.g., remotely) in combination with one or more actuators, and further in cooperation with a computing system or controller that receives the operator input and activates the actuator(s), as would be appreciated by one having ordinary skill in the art.

With reference to operations as described in association with FIGS. 1-7 (with focus on the mechanism 84 of FIG. 7 as used in the grain tank embodiments 12 of FIGS. 1-6D, with similar applicability to the grain tank embodiment 12B depicted in FIG. 7), one example for expanding the grain tank 12 (e.g., assuming a closed position at commencement) includes activating an actuator to cause the panel operating mechanism 84 to push the side panels 26 and 28 outward. Another actuator may be activated to cause a push up auger of the panel operating mechanism 84 to move upward. The front and rear panels 22B and 38B may be coupled to the push up auger via connecting rods attached thereto to unfold each concurrently (or substantially concurrently) with the expanding of the side panels 26 and 28. At the final open or expanded position, the foldable materials 24 and 40 are unfolded and in position to contain the grain along with the panels 26, 28, 22 and 38.

In the folding or closing operation, the push up auger and the front and rear panels 22B and 38B, respectively, are folded first, enabling the foldable material 24 and 40 to be ready for unfolding (closing operations). Subsequently, the side panels 26 and 28 are closed. In some embodiments, the foldable material 24 and 40 are configured such that the length to the side panel (e.g., 26 or 28) is equal to or shorter than the length attached to the rear side of the storage tank 12. In some embodiments, chains, springs, or any type of device may be used to make sure that the foldable material 24 and 40 remain inside of the grain tank 12, the latter facilitating folding of the material 24 and 40.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A storage container, comprising:
front and rear panels, each comprising a substantially upright fixed portion; and
a pivotal first side panel coupled to the front and rear panels and operable to transition between an expanded position and closed position, wherein a maximum width of the storage container as measured at a lower half of the storage container is greater in the expanded position than in the closed position,
wherein the front and rear panels further comprise a respective pivotal second portion, each pivotal second portion coupled to the respective upright fixed portion, wherein a front-facing surface of the second portion of the front panel and a rear-facing surface of the second portion of the rear panel in the expanded position are adjacent to an interior surface of the first side panel in the closed position.

2. The storage container of claim 1, further comprising a foldable material that attaches to the first side panel and the front and rear panels.

3. The storage container of claim 2, wherein the foldable material comprises rubber.

4. The storage container of claim 2, wherein the foldable material comprises a textile.

5. The storage container of claim 2, wherein the foldable material resides underneath the first side panel in the closed position.

6. The storage container of claim 1, wherein the second side panel is pivotal.

7. The storage container of claim 6, further comprising plural hinge assemblies, each of the hinge assemblies arranged fore and aft and in parallel to a respective lower edge of the first and second side panels, the first and second side panels mounted at the respective lower edge to the respective one of the hinge assemblies.

8. The storage container of claim 1, further comprising a hinge assembly, wherein a lower edge of the first side panel is mounted fore and aft to the hinge assembly and the second side panel is fixed in orientation relative to a host machine supporting the storage container, the second side panel comprising a hinge assembly arranged fore and aft and mounted to a top edge of the second side panel to pivotally support a side extension panel.

9. The storage container of claim 1, wherein a maximum storage capacity of the storage container is at least four hundred bushels.

10. A combine harvester, comprising:
a frame; and
a grain storage container mounted on the frame, the grain storage container comprising:
front and rear panels;
a first side panel mounted fore and aft on a lower hinge assembly, the first side panel comprising a top edge and a lower edge that form a non-zero angle relative to each other;
first and second foldable materials that couple the first side panel to the front and rear panels, the first foldable material attached to the front panel and the first side panel, the second foldable material attached to the rear panel and the first side panel;
wherein the front and rear panels further comprise a respective first fixed portion coupled to a respective pivotal second portion, each pivotal second portion coupled to the respective fixed portion, wherein a front-facing surface of the second portion of the front panel and a rear-facing surface of the second portion of the rear panel in an expanded grain storage container position are adjacent to an interior surface of the first side panel in the grain storage container configured in a closed position.

11. The combine harvester of claim 10, wherein the first and second foldable materials each comprises an elastomeric material, a textile, or a combination of both.

12. The combine harvester of claim 10, further comprising a second side panel, wherein the first and second foldable material reside underneath the first and second side panels when the top edge of the first side panel is oriented to a position adjacent a top edge of the second side panel.

13. The combine harvester of claim 12, wherein the second side panel is mounted fore and aft on a lower hinge assembly.

14. The combine harvester of claim 13, wherein when the first and second side panels are pivoted to close the grain storage container, the top edge of the second side panel is adjacent the top edge of the first side panel over a fore and aft midline of the grain storage container.

15. The combine harvester of claim 10, further comprising a second side panel, the second side panel comprising a fore and aft hinge assembly mounted to a top edge of the second side panel, the hinge assembly of the second side panel pivotally supporting a side extension panel.

16. The combine harvester of claim 10, wherein a maximum width of the grain storage container as measured at a lower half of the grain storage container is greater when the grain storage container is expanded than when it is closed.
